(19) United States
(12) Patent Application Publication
(10) Pub. No.: US 2003/0140756 A1
(43) Pub. Date: Jul. 31, 2003

(54) Venetian blind cutting machine

(75) Inventors: Jung-Kuei Lin, Hsinchu City (TW); Chyi-Liou Lin, Jubei City (TW)

Correspondence Address: BROWDY AND NEIMARK, P.L.L.C., 624 NINTH STREET, NW, SUITE 300, WASHINGTON, DC, 20001-5303, US

(73) Assignee: INDUSTRIAL TECHNOLOGY RESEARCH INSTITUTE, Hsinchu Hsien (TW)

(21) Appl. No.: 10/058,015

(22) Filed: Jan. 29, 2002

(51) Int. Cl. B26D 7/02

(52) U.S. Cl. 83/454; 83/613

(57) ABSTRACT

A Venetian blind cutting machine comprises a machine base. At least two molds are disposed at the machine base in different height levels. Each of the molds has at least one receiving hole for receiving raw material therein. At least one cutter slidably is disposed at one side of the molds. The traveling distance of the cutter can cross the receiving holes of the molds. A cutter driving assembly is disposed at the machine base for driving the cutter traveling, and a work table is disposed at one side of the machine base, which has seats thereon corresponding to the molds respectively for putting the raw materials thereon.

### FIELD OF THE INVENTION

The present invention relates generally to a Venetian blind, and more particularly to a Venetian blind cutting machine.

### BACKGROUND OF THE INVENTION

In early years, the Venetian blind was made from a cutting machine, which only can manufacture the head rail, the bottom rail and the slats one by one. Now, there are cutting machines can cut the elements of a Venetian blind in a single procedure. The prior arts, the Venetian blind cutting machine provided a mold, which provided which receiving holes thereon for the head rail, the bottom rail and the slats to be secured therein. Then a cutter, which is driven by motor or hydraulic press, cut them into the end items. This Venetian blind cutting machine is taught in U.S. Pat. No. 5,799,577, U.S. Pat. No. 5,927,172, and U.S. Pat. No. 6,079,306.

Because of the dimensions and the shapes of the head rail, the bottom rail and the slats are different. It needed different molds of the cutting machines to meet the different elements. In prior arts, the mold of the cutting machine cannot be replaced. So it needed a plurality of cutting machines with different molds to manufacture the elements of a Venetian blind. Although there were Venetian blind cutting machines, which can replace the molds, but the procedure of replacing molds is difficult. There was a lower performance of manufacturing a Venetian blind with the prior art because of the replacing molds.

### SUMMARY OF THE INVENTION

The primary objective of the invention is to provide a Venetian blind cutting machine, which can cut the different elements of a Venetian blind in one procedure without switching the molds frequently. More particular, it has a lower cost and a higher performance.

According to the objective of the invention, a Venetian blind cutting machine of the present invention comprises a machine base. At least two molds are disposed at the machine base in different height levels. Each of the molds has at least one receiving hole for receiving raw material therein. At least one cutter are slidably disposed at one side of the molds. The traveling distance of the cutter can cross the receiving holes of the molds. A cutter driving assembly is disposed at the machine base for driving the cutter traveling, and a work table is disposed at one side of the machine base, which has seats thereon corresponding to the molds respectively for putting the raw materials thereon.

### BRIEF DESCRIPTION OF THE DRAWINGS

FIG. 1 is a top view of a preferred embodiment of the present invention.

FIG. 2 is a right side view of the preferred embodiment of the present invention.

FIG. 3 is a front side view of the preferred embodiment of the present invention.

FIG. 4 is a sectional view taken along line 4-4 in FIG. 1.

FIG. 5 is a sectional view taken along line 5-5 in FIG. 1.

FIG. 6 is a sectional view taken along line 6-6 in FIG. 5.

FIG. 7 is a sectional view taken along line 7-7 in FIG. 1.

FIG. 8 is a sectional view taken along line 8-8 in FIG. 1.

### DETAIL DESCRIPTION OF THE INVENTION

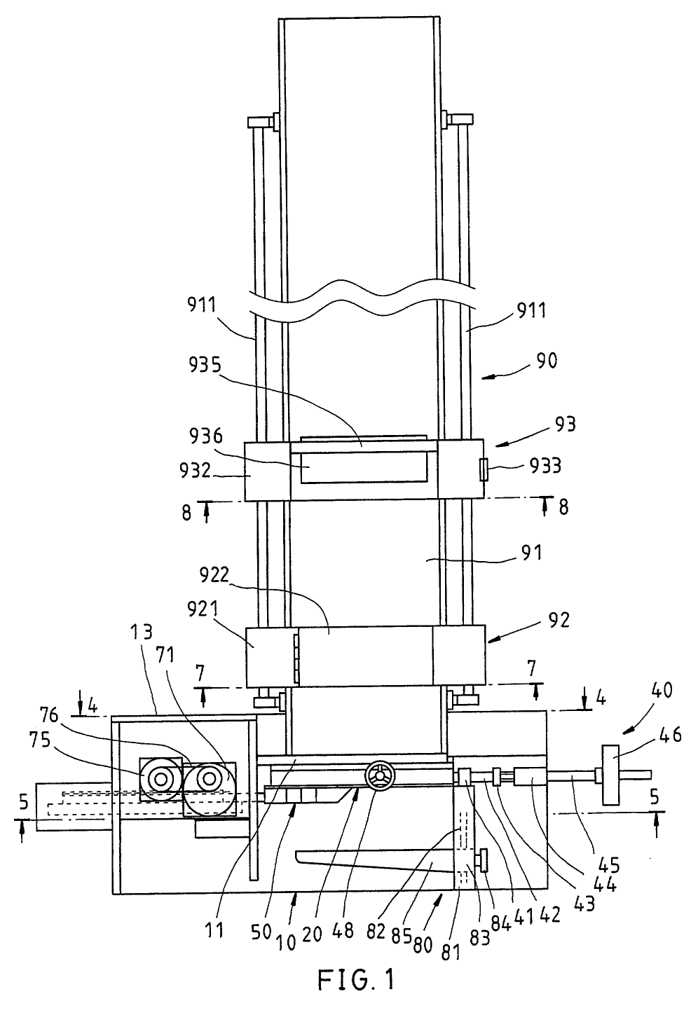

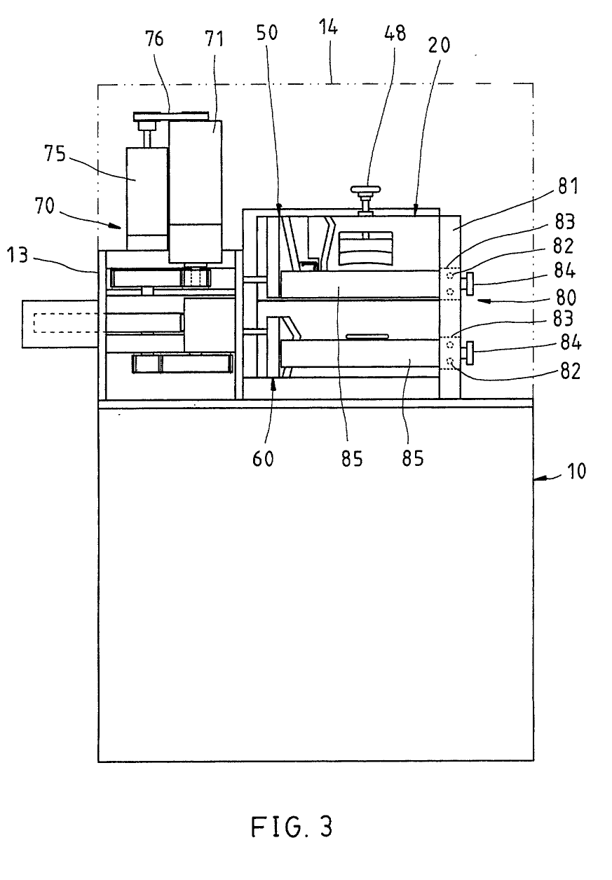

Please refer to FIG. 1 to FIG. 8, a Venetian blind cutting machine of the prefer embodiment of the present invention comprises:

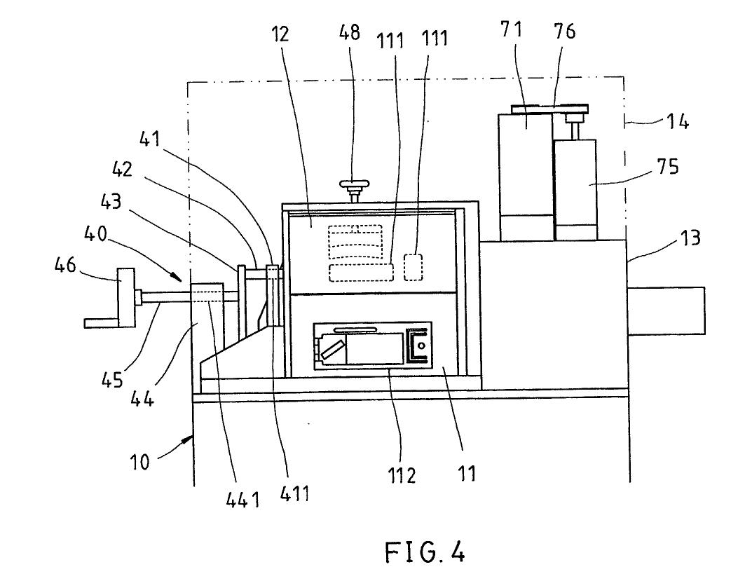

A machine base 10 provides with a seat plank 11 thereon. Please refer to FIG. 4, the seat plank 11 has an upper window 111 thereon and a lower window 112 below the upper window 111. A movable board 12 slidably engages to the seat plank 11. When the movable board 12 sliding to the top dead point, it will cover the upper window 111 and the lower window 112 will expose as shown in FIG. 4. On the contrary, when the movable board 12 sliding to the bottom dead point, the lower window 112 will be cover by the movable board 12 and the upper window 111 will expose (not shown). The machine bas 10 disposes with a box 13 next to the seat plank 11. A cover 14 covers the seat plank 11 and the box 13 (for the point of view to see the elements in detail, the box 13 is shown with a dotted line in FIG.).

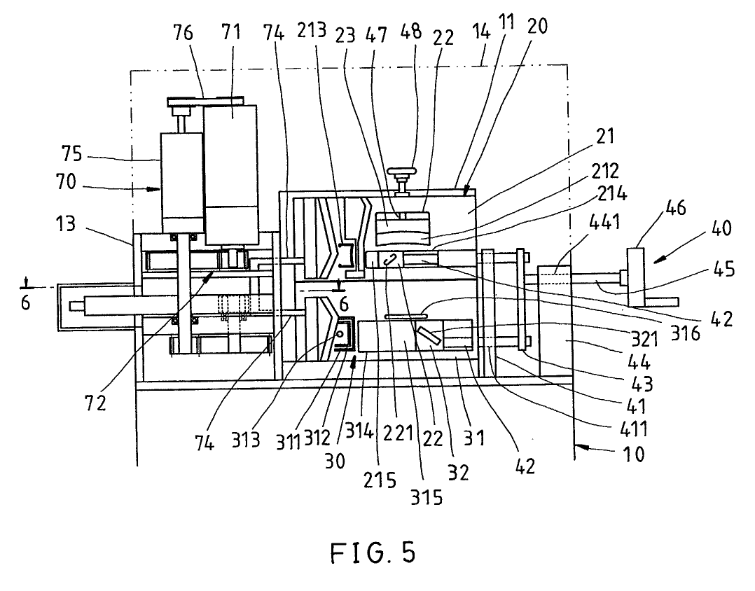

Please refer to FIG. 5, a first mold 20 and a second mold 30 dispose on the seat plank 11 at the side of opposite from the movable board 12. The first mold 20 comprises a main board 21 fixed at the seat plank 11 at topside thereof. The main board 21 has a vertical guiding slot 211 at topside thereof, a top-rail receiving hole 213 below the vertical guiding slot 211, and a transverse guiding slot 214 at the right side of the top-rail hole 213. A transverse sliding block 22 slidably engages to the transverse guiding slot 214, which has a bottom-rail receiving hole 221 thereon. A slat receiving hole 215 is formed in between the interior side of the transverse sliding block 22 and the interior side of the transverse guiding slot 214. A vertical sliding block 23 slidably engages to the vertical guiding slot 211. A large-slat receiving hole 212 is formed in between the bottom side of the vertical sliding block 23 and the bottom side of the vertical guiding slot 211. The receiving holes 213, 221, 215 and 212 of the first mold 20 are behind the upper window 111 of the seat plank 11. The second mold 30 has a main board 31 fixed at the seat plank 11 below the main board 21 of the first mold 20. The main board 31 of the second mold 30 has two top-rail receiving holes 311 and 312 with different dimensions at left side thereof, a guiding-bar receiving hole 313 at left side of the top-rail receiving holes 311, a transverse guiding slot 314 at the right side of top-rail receiving hole 312, and a decorative-board hole 316 above the transverse guiding slot 314. A transverse sliding block 32 slidably engages to the transverse guiding slot 314, which has a bottom-rail receiving hole 321 thereon. A slat receiving hole 315 is formed in between the interior side of the transverse sliding block 32 and the interior side of the transverse guiding slot 314. The receiving holes 311, 312, 313, 316, 321 and 315 of the second mold 30 are behind the lower window 112 of the seat plank 11. The main boards 21 and 31 of the first and the second molds 20 and 30 respectively provide with two guiding rails 216 and 317 at top ends and bottom ends thereof orientating in transverse direction.

A mold secure assembly 40, please refer to FIG. 5, comprises a stopping shaft seat 41 secured on the machine base 10 at the right side of the seat plank 11. The stopping shaft seat 41 has two transverse through holes 411 at top and bottom ends thereof respectively. Two stopping shafts 42 respectively receive in the transverse through holes 411 with the interior ends thereof receiving in the transverse guiding slots 214 and 314 of the first and the second molds 20 and 30 and being against the transverse sliding blocks 22 and 32. A connecting block 43 connects to the exterior ends of the stopping shafts 42. A screw shaft seat 44 secured on the machine base 10 at the right side of the stopping shaft seat 41. The screw shaft seat 44 has a transverse thread hole 441. A screw shaft 45 meshes with thread hole 441 with the interior end thereof being against the connecting block 43. A turning device 46 disposed at the exterior end of the screw shaft 45. While turning the turning device 46, it can drive the screw shaft 45 to shift inward or to shift outward.

The mold secure assembly 40 further comprises a second screw shaft 47 vertical screws through the main board 21 of the first mold 20 from the top end thereof to the bottom thereof and being against the vertical sliding block 23. A turning wheel 48 secured at the top end of the second screw shaft 47 for driving the second screw shaft 47 to shift inward and to shift outward. It has to mention here, it also can provide a motor for driving the screw shafts 45 and 47 to shift.

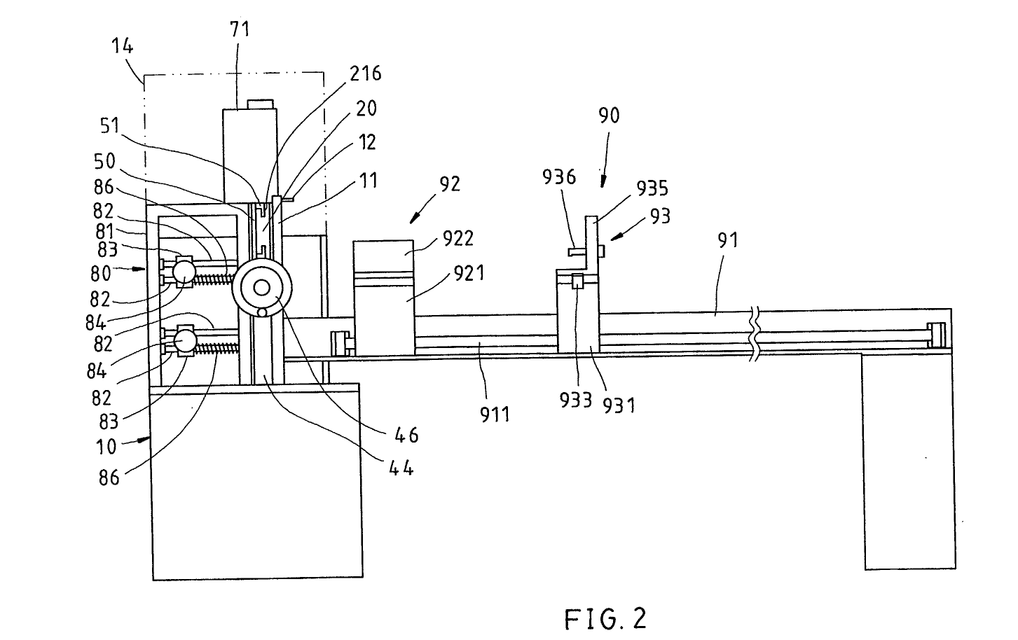

A first cutter 50 and a second cutter 60, please refer to FIG. 5, respectively dispose at the front sides of the first and the second molds 20 and 30. The first cutter 50 comprises two sliding pieces 51 engaging to the guiding rails 216 of the first mold 20 respectively as shown in FIG. 2. A base block 52 has the opposite ends thereof secured to the left ends of the sliding pieces 51 respectively. A first cutter board 53 secured at the midsections of the sliding pieces 5 1. A second cutter board 54 secured at the right ends of the sliding pieces 51. A passageway 501 is formed in between the first and the second cutter boards 53 and 54. The first cutter 50 is against the main board 21 of the first mold 20 and shift along transverse direction. When the first cutter 50 is shifting to the left dead point, as shown in FIG. 5, the passageway 501 is corresponding to the top-rail receiving hole 213 of the first mold 20, in which the first cutter board 53 positions at the left side of the top-rail receiving hole 213. In the meantime, the lower side of the first cutter board 53 positions a the location of between top-rail receiving hole 213 and the slat receiving hole 215, and the upper side thereof positions at the left side of the large-slat receiving hole 212. The second cutter 60 comprises two sliding pieces 61 engaging to the guiding rails 317 of the second mold 30 respectively. A base block 62 has the opposite ends thereof secured to the left ends of the sliding pieces 61. A cutter board 63 secured to the right ends of the sliding pieces 61. When the second cutter 60 is shifting to the left dead point, the cutter board 63 is positioning at the left side of the top-rail receiving holes 311 and 312 of the second mold 30.

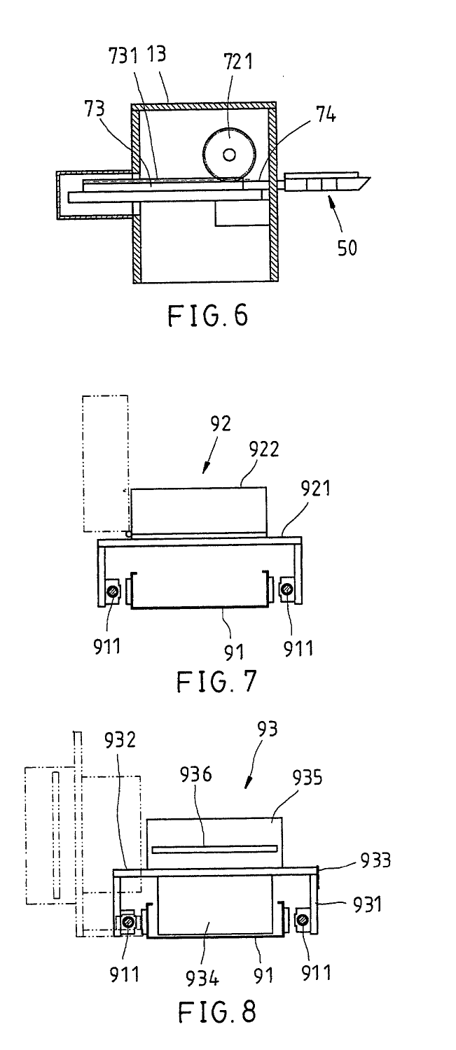

Please refer to FIG. 5 and FIG. 6, a cutter driving assembly 70 comprises an AC motor 71 disposed at the top end of the box 13 of the machine base 10 with an output shaft thereof inserting into of the box 13. A gear train 72 is to decrease the output speed of the AC motor 71. A shifting block 73 has a rack 731 meshing with an output gear 721 of the gear train 72 to be driven by the AC motor 71 to shift along transverse direction. Two connecting bars 74 have opposite ends thereof secured at the shifting block 73 and the base blocks 52 and 62 of the first and the second cutters 50 and 60. Whereby, when turning on the power, the AC motor 71 can drive the shifting block 73 to move and, in the meantime, the first and the second cutters 50 and 60 will move along with it. The cutter driving assembly 70 also can stop the first and the second cutters 50 and 60 at any position by setting sensors for detecting the shifting block 73 to control the AC motor 71 to stop and to turn reverse in specific time. That also can be done by providing a stepping motor controlled by a programming controller. The controlling means is not the main characteristic of the present invention, so we will not describe the detail.

In present embodiment, we further provide a DC motor 75 at the left side of the AC motor 71. A belt 76 connects the output shafts of the DC motor 75 and the AC motor 71. A battery (not shown) is to provide the DC motor 75 an essential electric power. Such that, the cutter driving assembly 70 still can work when electric power cut.

A blind stopping assembly 80, please refer to FIG. 1 to FIG. 3, comprises a frame 81 disposed on the machine at the front side of the screw shaft seat 44. Four guiding bars 82 have two of which being corresponding to the top-rail receiving hole 213, the slat receiving hole 215 and bottom-rail receiving hole 221 of the first mold 20, and the rest two of which being corresponding to the top-rail hole 311, slat hole 315 and the bottom-rail hole 321 of the second mold 30. Each pairs of the guiding bars 82 slidably disposed with a sliding block 83. Each of the sliding blocks 83 respectively has a holding segment 84 at the exterior side (the left side) thereof and a stopping board 85 at the interior side (the right side) thereof. The two stopping boards 85 cover at the front side of the receiving holes of the first and the second molds 20 and 30 respectively. Each pairs of the guiding bars 82 has a spring thereon for pushing the sliding block 83 outward.

A work table 90, please refer to FIG. 1 and FIG. 2, mounts at the back side of the machine base 10, which comprises an elongated flat table 91, a front supporting table 92 and a back supporting table 93. The elongated flat table 91 has one end thereof secured at the back side of the seat plank 11 of the machine base 10. The height of the elongated flat table 91 is substantially equal to the height of bottom ends of the receiving holes 311, 315 and 321 of the second mold 30. The elongated flat table 91 has a length scale (not shown) thereon. The elongated flat table 91 disposes with two guiding bars 911 at the lateral sides thereof respectively. Please refer to FIG. 7, the front supporting table 92 has a base seat 921 slidably engaged to the guiding bars 911. The top surface of the front supporting table 92 is corresponding to the receiving holes 213, 215 and 221 at the lower side of the first mold 20. A rotatable seat 922 has the left edge of bottom side thereof pivoted to the left end of the top surface of the base seat 921. The rotatable seat 922 can be turned to cover the top surface of the base seat 921 or can be turned outward shown as the dot line in FIG. 7. When the rotatable seat 922 is covering the base seat 921, the top surface of the rotatable seat 922 is corresponding to the large-slat receiving hole 212 at the upper side of the first mold 20. Please refer to FIG. 8, the back supporting table 93 has a locking seat 931 slidably engage to the guiding bar 911 at right side of the elongated flat table 91. A rotatable seat 932 slidably engages to the other guiding bar 911 at left side of the elongated flat table 91. The rotatable seat 932 can be turned to cover the top surface of the base seat 921 and can be secured to the locking seat 931 by a secure means 933. The rotatable seat 932 also can be turned outward shown as the dot line in FIG. 8. When the rotatable seat 932 is covering the elongated flat table 91, the height of top surface of the rotatable seat 932 is equal to the top surface of the base seat 921. The rotatable seat 932 has a lower stopping board 934 at bottom side thereof and an upper stopping board 935 at topside thereof. A horizontal board 936 slidably engages to the upper stopping board 935 for shifting parallel to elongated flat table 91. The height of the top surface of the horizontal board 936 is equal to the top surface of the rotatable seat 922 of the front supporting table 92.

Hereunder we will describe the cutting machine of the prefer embodiment of the present invention in operating:

The cutting machine of the present invention has a plurality of receiving holes in different dimensions for the raw materials of a Venetian blind, such as top rail, bottom rail, slats decorate board and guiding bar, to receive therein respectively These receiving holes respectively position at different height levels. So, we can put the corresponding raw materials on the work table 90 respectively.

For example, if we want to make some elements from the second mold 30. We should push the movable board 12 to the top dead point to make the receiving holes of the second mold 30 positioning in front of the work table 90. Then we put the raw materials on the elongated flat table 91 and pass through the base seat 921 of the front supporting table 92. On the contrary, if we want to use the receiving holes 213, 215 and 221 at the lower side of the first mold 20, we should push the movable board 12 to the bottom dead point. Then we turn the rotatable seat 922 of the front supporting table 92 outward, and push the horizontal board 936 of the back supporting table 93 to the back side. Now we can put the raw materials on the base seat 921 of the front supporting table 92 and the rotatable seat 932 of the back supporting table 93. If we want to use the large-slat receiving hole 212 at upper side of the first mold 20, then we should further turn the rotatable seat 922 of the front supporting table 92 to cover on the base seat 921, and push the horizontal board 936 to the front side. So, we can put the raw materials on the rotatable seat 922 and the horizontal board 936.

As described above, the work table 90 of the present invention has three levels to put the raw material, which are corresponding to the specific receiving holes of the first and the second molds 20 and 30.

After putting the raw materials on the work table 90, operator can push the back supporting table 93 forward to make the upper stopping board 935 or the lower stopping board 934 thereof to push the front ends of raw materials into the box 14 of the machine base 10. In the meantime, the raw materials will respectively pass through the corresponding receiving holes of the first and/or the second molds 20 or 30 via the upper window 111 and/or the lower window 112 on the seat plank 11. Now operator can read the scale on the elongated flat table 91 to determine the length of the raw materials should be cut. Then operator should grip the holding segment 84 of the blind stopping assembly 80 to drive the stopping board 85 shifting backward to make the front ends of the raw materials in the same level.

In order to cut large slats of the Venetian blind in larger lengths, it can provide an opening (not shown) at the front side of the box 14 of the machine base 10 for the large slats out of the box 14.

The cutting machine can cut the top rail, the bottom rail, the slats, and even the decorate board and the guiding bar in one procedure. Here we take the first mold for an example, if we want to cut the top rail, the bottom rail and the slats in the same time, we should put the raw materials into the top-rail receiving hole 213, the bottom-rail receiving hole 221 and the slat receiving hole 215 respectively and pass through the passageway 501 of the first cutter 50 and the passageway 601 of the first cutter 60. Because of the sectional shapes of the top-rail receiving hole 213 and the bottom -rail receiving hole 221 are as same as the top rail and the bottom rail of the Venetian blind, the raw materials can be positioned therein directly. The total dimension of the slats is different with the amount of the slat pieces that put in the slat receiving hole 215. So, we have to turn the turning device 46 of the mold secure assembly 40 by manpower or by electrical power to make the transverse sliding block 22 of the second mold 20 pressing the slat pieces. Similarly, for cutting the large slats, we have to turn the turning wheel 48 to make the second screw shaft 47 pressing the slat pieces.

After setting the raw materials up, we can start the cutter driving assembly 70 to drive the first and the second cutters 50 and 60 to cut the raw materials. We can control the traveling distances of the cutters 50 and 60 traveling to increase the cutting efficiency. For example, if there is no material putting in the receiving holes at right side of the molds, the cutters 50 and 60 only need to travel haft distance.

The advantages of the cutting machine of the present invention are:

1. There are a plurality of molds disposed on the cutting machine of the present invention, so it can operating on the elements of the Venetian blind in different dimensions. The efficiency of manufacturing Venetian blind will increase; because of there is no need to replace the molds of the cutting machine frequently. The cost of the equipments of manufacturing Venetian blind will be down too. Of course, the cutting machine of the present invention can replace the molds. We can make the mold as a module for facilitating to assemble and to disassemble.

2. The cutting machine of the present invention can work both under AC power supply and DC power supply, which means, it still can work when electric power cut.

What is claimed is:

1. A Venetian blind cutting machine comprising:
a machine base;
at least two molds disposed at said machine base at different height levels; each of said molds having at least one receiving hole for receiving raw material therein;
at least one cutter slidably disposed at one side of said molds; the traveling distance of said cutter can cross said receiving holes of said molds;
a cutter driving assembly disposed at said machine base for driving said cutter to travel, and
a work table disposed at one side of said machine base, which has seats thereon corresponding to said molds respectively for putting the raw materials thereon.

2. The Venetian blind cutting machine as defined in claim 1, wherein said machine base has a seat plank, which has windows thereon; each of said molds having a main board secured at one side of said seat plank; each of said main boards having a top-rail receiving hole and a transverse guiding slot; a transverse sliding block slidably engaging to said transverse guiding slot, which has a bottom-rail receiving hole thereon; a slat receiving formed in between said transverse sliding block and said transverse guiding slot; said receiving holes being behind said windows of said seat plank; further comprising a mold stopping assembly, which has a stopping shaft seat disposed at said seat plank corresponding to the exterior side of said transverse guiding slot; said stopping shaft seat having at least two transverse through holes thereon respectively corresponding to said transverse guiding slots; at least two stopping shafts respectively passing through said transverse through holes and receiving in said transverse guiding slots; a connecting block disposed at the exterior ends of said stopping shafts; a screw shaft seat disposed at said stopping shaft seat at the side of opposite from said molds; said screw shaft seat having a transverse thread hole; a screw shaft mesh with said transverse thread hole for the interior end thereof can be against said connecting block for driving said stopping shaft to move.

3. The Venetian blind cutting machine as defined in claim 1, wherein said top mold has a vertical guiding slot thereon; a vertical sliding block slidably engaging to said vertical guiding slot; a screw shaft passing through said mold from the top end of said mold to the bottom end of said mold; the bottom end of said screw shaft being against said vertical sliding block for driving said vertical sliding block to move.

4. The Venetian blind cutting machine as defined in claim 1, wherein said cutter locates at sides of said molds respectively; said cutter driving assembly can drive said cutters to travel together.

5. The Venetian blind cutting machine as defined in claim 4, wherein each of said molds has two transverse guiding rails at topside and bottom side thereof respectively; each of said cutters having two sliding pieces at topside and bottom side thereof slidably engaging to said guiding rails respectively.

6. The Venetian blind cutting machine as defined in claim 1, wherein said cutter driving assembly comprises an AC motor, a gear train disposed at the output shaft of said AC motor for decreasing the output speed of said AC motor; a shifting block slidably disposed on said machine base for sliding in transverse direction, which has a rack thereon for meshing with an output gear of said gear train; each of said cutters connecting to said shifting block respectively by a connecting bar.

7. The Venetian blind cutting machine as defined in claim 6, wherein said cutter driving assembly further comprises a DC motor disposed beside said AC motor; a belt providing on the output shafts of said AC motor and said DC motor.

8. The Venetian blind cutting machine as defined in claim 1 further comprising a blind stopping assembly, which comprises a frame disposed at said machine base beside said molds; at least one guiding bar disposed at said frame; at least one sliding block slidably engaging to said guiding bar, which has a holding segment thereon for user to grip and a stopping board against the front ends of the raw materials; at least one spring disposed on said guiding bar for pushing said sliding block in the direction of away said molds.

9. The Venetian blind cutting machine as defined in claim 8, wherein the amount of said sliding blocks are equal to said molds and positioning at different height levels of corresponding to said molds respectively.

10. The Venetian blind cutting machine as defined in claim 1, wherein said work table comprises an elongated flat table, a front supporting table and a back supporting table; one end of said elongated flat table being closing to said molds; said elongated flat table having two guiding bars thereon; said front supporting table having a base seat disposed at the topside of said elongated flat table and engaging to said guiding bars for free sliding; a rotating seat having one end of the bottom side thereof pivoting with said base seat to be turned inward to cover said base seat and to be turned outward; said back supporting table disposed beside the front supporting table at the side of opposite from said molds, which comprises a locking seat slidably engaging to one of said guiding bars of said elongated flat table, and a rotating seat having one end thereof engaging to the other one of said guiding bars, such that said can be turned inward to against the top end of said locking seat and can be turned outward; a lower stopping board having one end thereof disposed at the bottom side of said rotating seat; an upper stopping board having one end thereof disposed at the top side of said rotating seat; a horizontal board slidably engaging to said upper stopping board for free shifting in transverse direction.

11. The Venetian blind cutting machine as defined in claim 10, wherein said elongated flat table is provided with a length scale thereon for reading the length of the raw material.
